(19) United States
(12) Patent Application Publication
(10) Pub. No.: US 2025/0268152 A1
(43) Pub. Date: Aug. 28, 2025

(54) CORRUGATED PAPER CONTAINER

(71) Applicant: WestRock Shared Services, LLC, Atlanta, GA (US)

(72) Inventors: Kevin M. SIMPKINS, Cumming, GA (US); Jeffrey S. JAMES, Elmhurst, IL (US)

(21) Appl. No.: 19/060,955

(22) Filed: Feb. 24, 2025

Related U.S. Application Data
(60) Provisional application No. 63/557,230, filed on Feb. 23, 2024.

(51) Int. Cl. A01G 9/02; B65D 85/52

(52) U.S. Cl. CPC A01G 9/026; B65D 85/52

(57) ABSTRACT

A horticulture container that includes a substrate that is integrally formed. The substrate includes faces interconnected and separated by creases, a lip formed by the faces, and one or more tabs that are secured to at least one of the faces to maintain a shape of the horticulture container. The faces define a cavity of the horticulture container. The cavity is enclosed by the faces and access to the cavity is only permitted through the opening.

### TECHNICAL FIELD

This disclosure relates generally to containers, and more particularly, to corrugated paper containers.

### BACKGROUND

Various types and configurations of horticulture containers are presently available, such as ceramic pots, plastic horticulture containers, barrels, wire baskets, and the like. By way of example, conventionally, plastic pots may be popular due to their relatively low cost compared to other types of horticulture containers, durability, and manufacturability. However, once a horticulture item (e.g., a plant) is removed from the plastic pot for permanent planting, disposal of the plastic pot and/or finding a suitable recycling chain may be difficult. Similarly, the plastic port may not be environmentally friendly, thereby rendering the plastic pot unrecyclable.

### SUMMARY

In one aspect of the present disclosure, a horticulture container is disclosed. The horticulture container includes a substrate that is integrally formed. The substrate includes faces interconnected and separated by creases, a lip formed by the faces, and one or more tabs that are secured to at least one of the faces to maintain a shape of the horticulture container. The faces define a cavity of the horticulture container. The cavity is enclosed by the faces and access to the cavity is only permitted through the opening.

In some configurations, the one or more tabs may be secured in one or more slots defined by the substrate. The one or more slots may be formed in at least one of the faces. The one or more tabs may be adhered to at least one of the faces. The substrate may include a crush zone positioned adjacent to each of the one or more slots.

In some configurations, the substrate may be a corrugated paper material.

In some configurations, the substrate may include one or more panels interconnected and separated by fold lines. The faces may be located on the one or more panels. The one or more may be configured to be folded relative to each other along the fold lines and the faces are configured to be folded relative to each other along the creases to define and form the shape of the horticulture container. Additionally, the one or more panels may include a first panel, a second panel, and a center panel located between, and connected to, the first panel and the second panel. The first panel, the second panel, or both may include a slot that may be configured to receive the one or more tabs. The one or more tabs may be located on, or connected to, the center panel. The one or more tabs, the first panel, and the second panel may extend from the center panel. The one or more tabs may extend in a direction generally orthogonal to the first panel and the second panel.

In some configurations, the first panel and the second panel may each include a first portion, a second portion, and a center portion located between, and connected to, the first portion and the second portion. The center portion of the first panel may be connected to the center panel by a first fold line and the center portion of the second panel may be connected to the center panel by a second fold line. The first portion and the second portion of the first panel and the first portion and the second portion of the second panel may be free of direct connection to the center panel.

In some configurations, the creases may intersect to form a diamond pattern.

In another aspect of the present disclosure, a method of forming a horticulture container is disclosed. The method includes obtaining a substrate formed from a paper material. The substrate includes a first panel that includes faces interconnected by creases, a second panel that includes faces interconnected by creases, a center panel located between, and connected to, the first panel and the second panel by a first fold line and a second fold line, respectively, one or more tabs connected to the center panel by one or more additional fold lines, and one or more slots formed in the first panel, the second panel, or both. The method further includes folding the first panel with respect to the center panel along the first fold line, folding the second panel with respect to the center panel along the second fold line, folding the one or more tabs with respect to the center panel along the one or more additional fold lines, and inserting the one or more tabs into the one or more slots.

In some configurations, the method may further include adhering the one or more tabs to the first panel, the second panel, or both.

In some configurations, the substrate may further include a center fold line that bisects the center panel and extends in a direction generally parallel to the first fold line and the second fold line. The method may further include folding the center panel along the center fold line.

In some configurations, the first fold line and the second fold line may extend generally perpendicular to the one or more additional fold lines.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a perspective view of a horticulture container in accordance with the present disclosure.

FIG. 2 is a perspective view of a substrate in an unfolded state that forms the horticulture container of FIG. 1.

FIG. 3A is a planar view of another example of a substrate in an unfolded state.

FIG. 3B is a perspective view of a horticulture container formed from the substrate of FIG. 3A.

FIG. 4A is a planar view of another example of a substrate in an unfolded state.

FIG. 4B is a perspective view of a horticulture container formed from the substrate of FIG. 3A.

### DETAILED DESCRIPTION

The present teachings generally relate to horticulture containers. The horticulture containers may be a pot, barrel, bucket, or other type of container that may be configured to contain or other secure various horticulture items, such as a plant. That is, the horticulture containers as described herein may at least partially house plants permanently and/or temporarily. For example, the horticulture containers may be configured for temporarily storing plants in consumer stores for purchase, whereby a consumer may purchase the plant, transport the plant to another location via the horticulture container, and transplant the plant to a permanent location, at which point the horticulture container may be disposed.

It should be noted that while horticulture containers are described herein, the horticulture containers may also be used in any other industries. For example, the containers described herein may be used in the food and beverage industry, agriculture industry, construction industry, other industries, the like, or a combination thereof. That is, it is envisioned that the containers described herein may provide a means for storing and/or transporting any type of items and are not limited to just horticulture items (e.g., plants).

Advantageously, the disposal of the horticulture container may be environmentally friend. For example, the horticulture container may be made from various paper materials that may provide an alternative to unrecyclable conventional plant containers, such as plastic pots. While not limited to any particular type of material, it is envisioned that the horticulture containers described herein may be made from corrugated paper materials, paperboard, other thin paper substrates, the like, or a combination thereof. As a result, of using such materials, the horticulture container may be more environmentally friendly. That is, the horticulture container may be recyclable, compostable, biodegradable, or a combination thereof.

The horticulture container may also contain one or more environmentally friendly additives and/or coatings that may provide additional material properties. For example, the horticulture container may include one or more coatings and/or one or more additives that result in the horticulture container being moisture-resistant, corrosion-resistant, or both. Similarly, the horticulture container may be ultraviolet (UV) resistant, anti-microbial, anti-fungal, waterproof, insect repellent, or a combination thereof.

Moreover, the horticulture container may provide additional benefits compared to the aforementioned conventional horticulture containers. For example, the horticulture container may be formed from a single, monolithic substrate (e.g., a paper-based substrate). As a result, manufacturing of the horticulture container may be less complex compared to conventional containers, thereby reducing material waste and/or overall manufacturing costs. Thus, the teachings herein may provide a horticulture container that is recyclable and/or biodegradable, easier to manufacture, and cheaper.

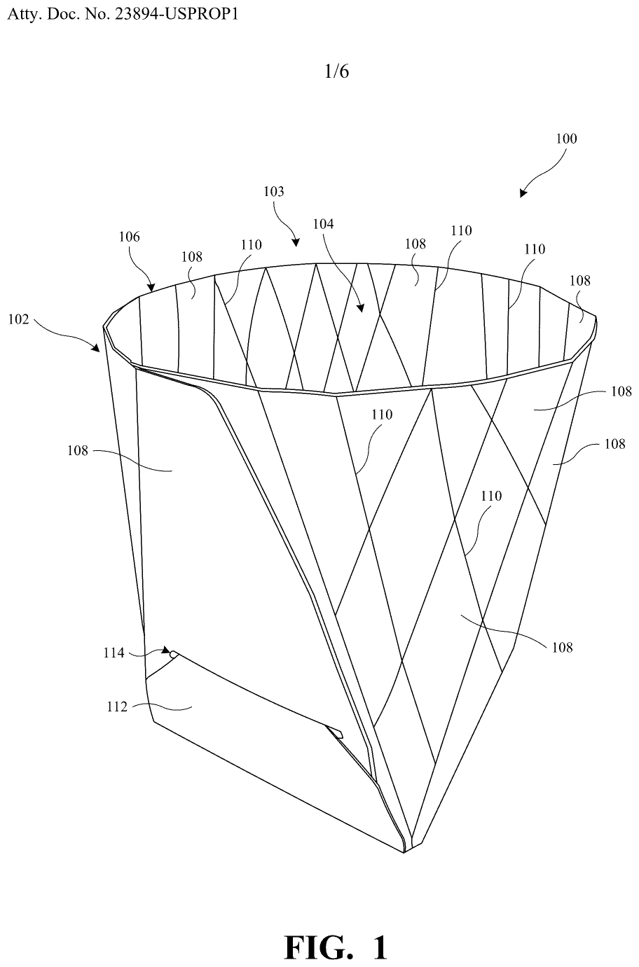

Turning now to the figures, FIG. 1 illustrates a perspective view of a horticulture container 100 in accordance with the present teachings. The horticulture container 100 may be formed from a substrate 102. As discussed further below, the substrate 102 may be folded or otherwise manipulated to create a general shape (e.g., geometry) of the horticulture container 100. As discussed above, the substrate 102 may be made of a paper material (e.g., corrugated paper material) that may provide an alternative to conventional horticulture containers, such as plastic pots.

As shown in FIG. 1, the substrate 102 may form an overall shape of the horticulture container 100 and define a cavity 104 therein. The cavity 104 may be an interior space of the horticulture container 100 that may receive (e.g., house) a plant. That is, the cavity 104 may be filled with soil or similar materials such that the plant may be planted directly into the horticulture container 100. As such, the substrate 102 (e.g., an interior surface of the substrate 102) may be in direct contact with soil, the plant, moisture (e.g. water), or a combination thereof.

The substrate 102 may include faces 108 interconnected by creases 110 such that the faces 108 may be folded relative to each other to form a contour and/or shape of the horticulture container 100. Additionally, at least a portion of the faces 108 may terminate at a lip 106 of the horticulture container 100. The lip 106 may define an opening 103 that may permit access to the cavity 104.

As discussed further below, the substrate 102 may be monolithically (i.e., integrally) formed as a single piece. As a result, the substrate 102 may form substantially all or an entirety of the horticulture container 100. In such a case, the opening 103 defined by the lip 106 may form the only access point to the cavity 104. That is, the cavity 104 may be enclosed by the faces 108 and access to the cavity 104 may only be permitted through the opening 103.

To secure the substrate 102 to itself and maintain a shape of the horticulture container 100, the horticulture container 100 may also include one or more tabs 112. The tabs 112 may be secured to, or connected to, at least one of the faces 108 to maintain a shape of the horticulture container 100. For example, the tabs 112 may extend into, and be secured within, one or more slots 114 defined by the substrate 102. It should also be noted that the horticulture container 100 may be free of the tabs 112. For example, the horticulture container 100 may be free of the tabs 112 such the one or more portions of the substrate 102 (e.g., the faces 108, panels etc.) may be adhered to one another to maintain the shape of the horticulture container 100.

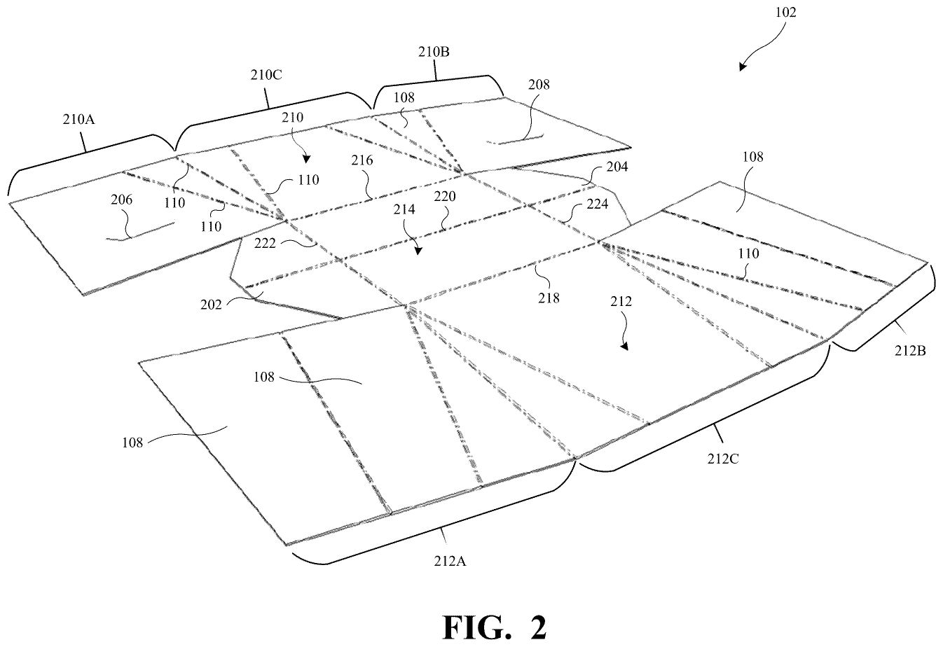

FIG. 2 illustrates a perspective view of the substrate 102. As described above, the substrate 102 may be folded or otherwise manipulated to form the horticulture container 100 shown in FIG. 1.

The substrate 102 may include a first panel 210, a second panel 212, and a center panel 214. The first panel 210 and the second panel 212 may be connected to (e.g., formed with) the center panel 214. The center panel 214 may be positioned between, and connected to, the first panel 210 and the second panel 212. For example, the center panel 214 may be connected to the first panel 210 by a first fold line 216 and the center panel 214 may be connected to the second panel 212 by a second fold line 218. As such, the center panel 214 may disposed between the first panel 210 and the second panel 212. It should be noted that the substrate 102 may also include one or more additional panels or less panels than shown in FIG. 2.

The first panel 210 and the second panel 212 may each include one or more portions. By way example the first panel 210 may include a first portion 210A and a second portion 210B connected to a center portion 210C. Similarly, the second panel 212 may include a first portion 212A and a second portion 212B connected to a center portion 212C. The connections between the aforementioned portions may be facilitated by the creases 110. Additionally, one or more of the aforementioned portions (e.g., the first portion 210A, the second portion 210B, and/or the center portion 210C of the first panel 210 and/or the first portion 212A, the second portion 212B, and/or the center portion 212C of the second panel 212) may contain or include the faces 108. That is, the aforementioned portions may be at least partially formed by the faces 108.

As shown in FIG. 2, the center portion 210C of the first panel 210 may be connected to the center panel 214 by the first fold line 216 and the center portion 212C of the second panel 212 may be connected to the center panel 214 by the second fold line 218. As such, the first panel 210 and the second panel 212 may be folded with respect to the center panel 214 along the first fold line 216 and the second fold line 218.

Additionally, the center panel 214 may include a center fold line 220 such that portions of the center panel 214 may be folded with respect to each other along the center fold line 220. The center fold line 220, the first fold line 216, and the second fold line 218 may extend in any direction and may converge or diverge relative to one another. The center fold line 220, the first fold line 216, and the second fold line 218 may also be substantially parallel to one another.

As described above, the horticulture container 100 may also include the tabs 112. By way of example, the substrate 102 may include a first tab 202 connected to the center panel 214 by a first tab fold line 222 and a second tab 204 connected to the center panel 214 by a second tab fold line 224. The first tab 202 may be folded with respect to the center panel 214 along the first tab fold line 222 and the second tab 204 may be folded with respect to the center panel 214 along the second tab fold line 224. The first tab fold line 222 and/or the second tab fold line 224 may extend generally nonparallel (e.g., perpendicular) to the first fold line 216, the second fold line 218, the center fold line 220, or a combination thereof.

To illustrate forming the horticulture container 100, the substrate 102 may be folded and secured to itself as described below. However, such method of folding is only one manner of creating the horticulture container 100, and various other sequences may be possible based on the configuration of the substrate 102.

The first panel 210 may be folded with respect to the center panel 214 along the first fold line 216 and the second panel 212 may be folded with respect to the center panel 214 along the second fold line 218. Similarly, the center panel 214 may be bisected by the center fold line 220 such that the center panel 214 may be folded relative to itself along the center fold line 220 such that the center panel 214 may generally form a base of the horticulture container (e.g., a base of the cavity 104).

Additionally, the first tab 202 may be folded with respect to the center panel 214 along the first tab fold line 222 and the second tab 204 may be folded with respect to the center panel 214 along the second tab fold line 224. Moreover, the first portion 210A, the second portion 210B, and the center portion 210C of the first panel 210 may be folded with respect to one another along the creases 110. Similarly, the first portion 212A, the second portion 212B, and the center portion 212C of the second panel 212 may be folded with respect to one another along the creases 110. As a result, the faces 108 of the first panel 210 and the second panel 212 may form the various facets of the horticulture container 100 (e.g., an overall geometry of the horticulture container 100).

Due to the above folding, the first tab 202 may be inserted into a first slot 206 defined by the first panel 210 and the second tab 204 may be inserted into a second slot 208 defined by the first panel 210 to secure the substrate 102 in its folded state and form the horticulture container 100. The first slot 206 and the second slot 208 may be located anywhere along the substrate 102, such as on the first panel 210 and/or the second panel 212. As shown in FIG. 2, the first slot 206 may be located on the first portion 210A of the first panel 210 and the second slot 208 may be located on the second portion 210B of the first panel 210.

It should be noted that any of the above features may be any geometry or configuration to facilitate the above forming of the horticulture container 100. For example, the first tab 202 and the second tab 204 may be any size and/or shape, may contain one or more projections, one or more edges, one or more engaging features, the like, or a combination thereof. Similarly, the first slot 206 and the second slot 208 may be a cutout, slit, notch, groove, opening, engaging portion, the like, or a combination thereof that may engage and connect to the first tab 202 and the second tab 204, respectively.

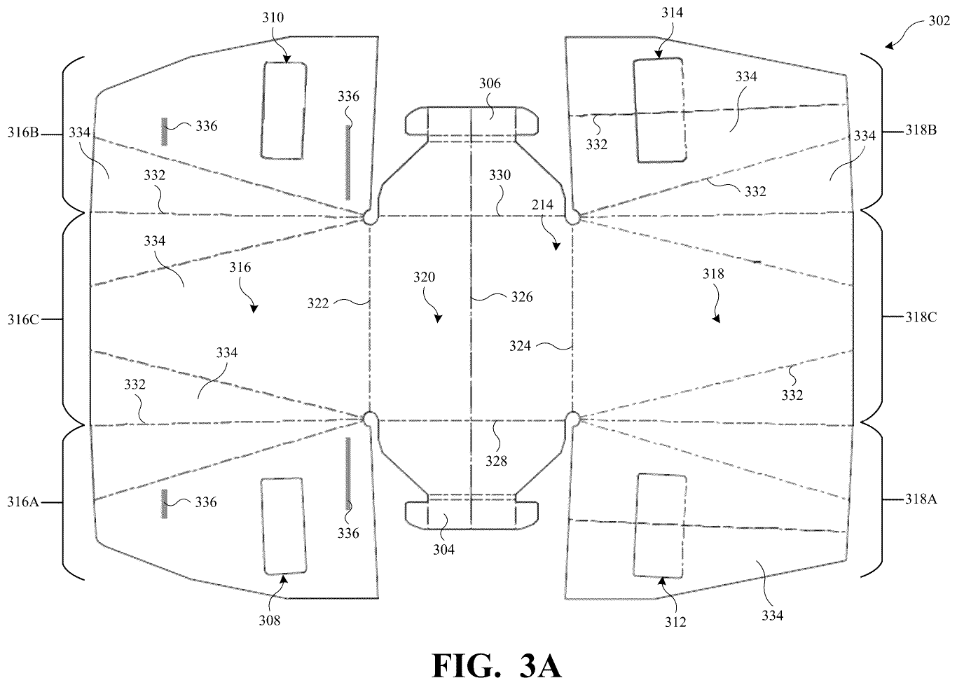

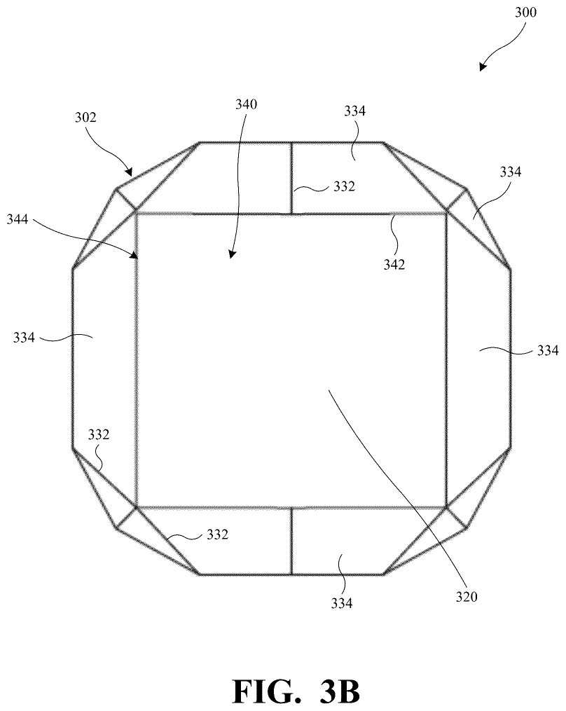

FIG. 3A illustrates a planar view of another example of a substrate 302 that may form a horticulture container similar to the horticulture container 100 described above. The substrate 302 may be similar to the substrate 102 unless otherwise stated.

The substrate 302 may include a first panel 316, a second panel 318, and a center panel 320. The first panel 316 and the second panel 318 may be connected to (e.g., formed with) the center panel 320. The center panel 320 may be positioned between and connected to the first panel 316 and the second panel 318 by a first fold line 322 and a second fold line 324, respectively.

The first panel 316 and the second panel 318 may each include one or more portions. By way of example, the first panel 316 may include a first portion 316A and a second portion 316B connected to a center portion 316C. Similarly, the second panel 318 may include a first portion 318A and a second portion 318B connected to a center portion 318C. The connections between the aforementioned portions may be facilitated by creases 332, which may be score lines, localized weak points of the first panel 316 and/or the second panel 318, perforations, predefined fold lines, the like, or a combination thereof. The creases 332 may be similar to the creases 110 described above. Additionally, one or more of the aforementioned portions may contain or include one or more faces 334, which may be similar to the faces 108 described above.

As shown in FIG. 3A, the center portion 316C of the first panel 316 may be connected to the center panel 320 by the first fold line 322 and the center portion 318C of the second panel 318 may be connected to the center panel 320 by the second fold line 324. As such, the first panel 316 and the second panel 318 may be folded with respect to the center panel 320 along the first fold line 322 and the second fold line 324.

Additionally, the center panel 320 may include a center fold line 326 such that portions of the center panel 320 may be folded with respect to each other along the center fold line 326. The center fold line 326 may be substantially parallel to the first fold line 322 and/or the second fold line 324. It should also be noted that only a portion of the first panel 316 and/or the second panel 318 may be connected to the center panel 320. For example, the first portion 316A and the second portion 316B of the first panel 316 may be free of direct connection to the center panel 320 and may be connected to the center panel 320 only by the center portion 316C of the first panel 316. Similarly, the first portion 318A and the second portion 318B of the second panel 318 may be free of direct connection to the center panel 320 may be connected to the center panel only by the center portion 318C of the second panel 318.

The substrate 302 may also include a first tab 304 connected to the center panel 320 by a first tab fold line 328 and a second tab 306 connected to the center panel 320 by a second tab fold line 330. The first tab fold line 328 and the second tab fold line 330 may be referred to as additional fold lines of the substrate 302. The first tab 304 and the second tab 306 may be folded along their respective fold lines with respect to the center panel 320. As shown, the first tab 304, the second tab 306, the first panel 316, and the second panel 318 may all extend from the center panel 320, whereby the first tab 304 and the second tab 306 may extend substantially orthogonal to the first panel 316 and the second panel 318. However, any orientation is possible.

Forming a horticulture container using the substrate 302 may be done in a similar manner to the folding of the substrate 102 described above. That is, the first panel 316 and the second panel 318 may be folded with respect to the center panel 320 along the first fold line 322 and the second fold line 324, respectively. Similarly, the first tab 304 and the second tab 306 may be folded with respect to the center panel 320 along the first tab fold line 328 and the second tab fold line 330, respectively. The center panel 320 may also be folded relative to itself along the center fold line 326.

The aforementioned portions of the first panel 316 and the second panel 318 may be folded relative to each other along the creases 332 so that the first tab 304 and the second tab 306 may be secured to the first panel 316 and the second panel 318. The creases 332 may be oriented in any desired manner relative to one another. By way of example, the first panel 316 may define a first slot 308 and a second slot 310 and the second panel 318 may define a third slot 312 and a fourth slot 314. The aforementioned folding may facilitate insertion of the first tab 304 into the first slot 308 and the third slot 312 and insertion of the second tab 306 into the second slot 310 and the fourth slot 314. In particular, engaging portion of the first tab 304 may be inserted into the first slot 308 and the third slot 312 and engaging portions of the second tab 306 may be inserted into the second slot 310 and the fourth slot 314. As a result, the folded shape of the substrate 302 may be maintained.

To further secure the substrate 302 in a folded state, the first panel 316 and/or the second panel 318 may include adhesive portions 336. By way of example, adhesive portions 336 (e.g., an adhesive) may be disposed on the first portion 316A and the second portion 316B of the first panel 316 near and/or adjacent to the first slot 308 and the second slot 310. As such, when the substrate 302 is folded and the first tab 304 and the second tab 306 are inserted into their respective slots, the adhesive portions 336 may be adhered to a portion of the first tab 304 and/or the second tab 306. Similarly, the adhesive portions 336 may also adhere to at least a portion of the faces 334. That is, the first tab 304 and the second tab 306 may be adhered to at least one of the faces 334.

FIG. 3B illustrates a top view of a horticulture container 300 that may be formed by the substrate 302 described above. That is, the substrate 302 may be folded or otherwise manipulated to form the horticulture container 300. The horticulture container 300 may be similar to the horticulture container 100 described above.

As shown in FIG. 3B, the faces 334 of the first panel 316 and the second panel 318 may be folded relative to each other along the creases 332 to form an overall shape of the horticulture container 300. Similarly, the faces 334, including the first panel 316 and the second panel 318 as a whole, may be folded with respect to the center panel 320 to define a cavity 340 of the horticulture container 300. As such, the center panel 320 may form a base support or base of the horticulture container 300 such that, when soil and/or a plant is inserted into the cavity 340, the center panel 320 may support the soil and/or the plant.

The faces 334 of the first panel 316 and the second panel 318 may terminate at one end and form a lip 342 around the cavity 340. That is, the lip 342 may define an opening 344 of the cavity 340 that may permit access to the cavity 340 (e.g., for potting a plant or other horticulture item).

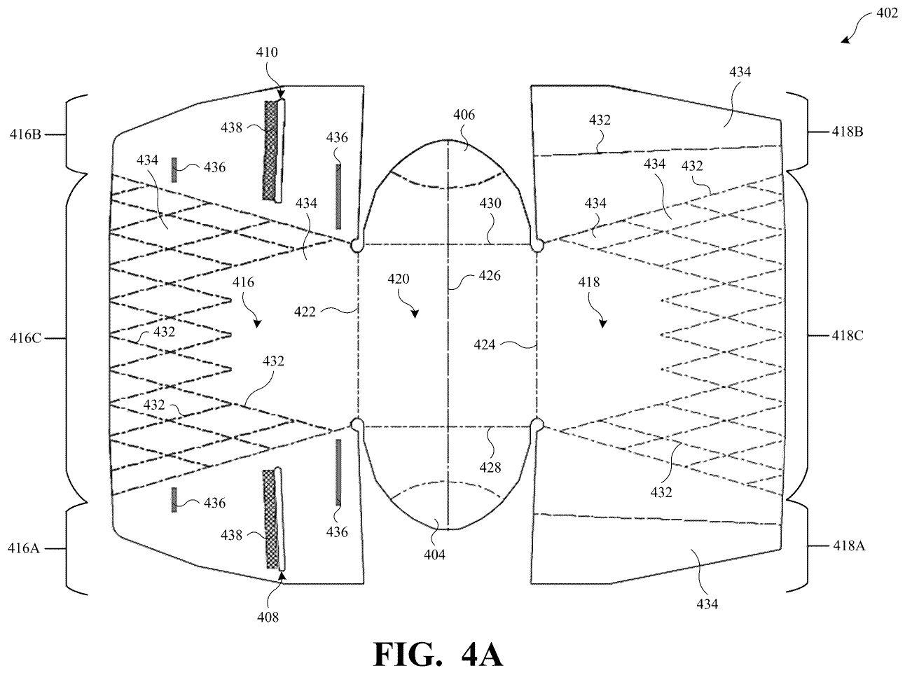

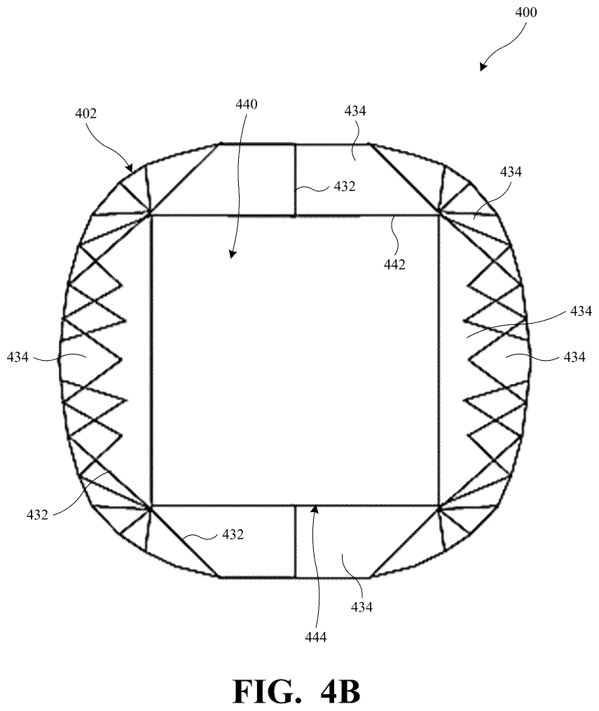

FIG. 4A illustrates a planar view of another example of a substrate 402 that may form a horticulture container similar to the horticulture container 100 and the horticulture container 300 described above. The substrate 402 may be similar to the substrate 102 and the substrate 302 unless otherwise stated.

The substrate 402 may include a first panel 416, a second panel 418, and a center panel 420. The first panel 416 and the second panel 418 may be connected to (e.g., formed with) the center panel 420. The center panel 420 may be positioned between and connected to the first panel 416 and the second panel 418 by a first fold line 422 and a second fold line 424, respectively.

The first panel 416 and the second panel 418 may each include one or more portions. By way of example, the first panel 416 may include a first portion 416A and a second portion 416B connected to a center portion 416C. Similarly, the second panel 418 may include a first portion 418A and a second portion 418B connected to a center portion 418C.

The connections between the aforementioned portions may be facilitated by creases 432, which may be score lines, localized weak points of the first panel 416 the second panel 418, the center panel 420, or a combination thereof, perforations, predefined fold lines, the like, or a combination thereof. The creases 432 may be similar to the creases 110 and the creases 332 described above. The creases 432 may intersect to form a general pattern. For example, the creases 432 may form a diamond-shaped pattern, a hexagonal pattern, a lattice pattern, the like, or a combination thereof. Additionally, one or more of the aforementioned portions may contain or include one or more faces 434, which may be similar to the faces 108 and the faces 334 described above.

As shown in FIG. 4A, the center portion 416C of the first panel 416 may be connected to the center panel 420 by the first fold line 422 and the center portion 418C of the second panel 418 may be connected to the center panel 420 by the second fold line 424. As such, the first panel 416 and the second panel 418 may be folded with respect to the center panel 420 along the first fold line 422 and the second fold line 424.

Additionally, the center panel 420 may include a center fold line 426 such that portions of the center panel 420 may be folded with respect to each other along the center fold line 426. The center fold line 426 may be substantially parallel to the first fold line 422 and/or the second fold line 424. It should also be noted that only a portion of the first panel 416 and/or the second panel 418 may be connected to the center panel 420. For example, the first portion 416A and the second portion 416B of the first panel 416 may be free of direct connection to the center panel 420 and may be connected to the center panel 420 only by the center portion 416C of the first panel 416. Similarly, the first portion 418A and the second portion 418B of the second panel 418 may be free of direct connection to the center panel 420 may be connected to the center panel 420 only by the center portion 418C of the second panel 418.

The substrate 402 may also include a first tab 404 connected to the center panel 420 by a first tab fold line 428 and a second tab 406 connected to the center panel 420 by a second tab fold line 430. The first tab fold line 428 and the second tab fold line 430 may be referred to as additional fold lines of the substrate 402. The first tab 404 and the second tab 406 may be folded along their respective fold lines with respect to the center panel 420. As shown, the first tab 404, the second tab 406, the first panel 416, and the second panel 418 may all extend from the center panel 420, whereby the first tab 404 and the second tab 406 may extend substantially orthogonal to the first panel 416 and the second panel 418. However, any orientation is possible.

Forming a horticulture container using the substrate 402 may be done in a similar manner to the folding of the substrate 102 or the substrate 302 described above. That is, the first panel 416 and the second panel 418 may be folded with respect to the center panel 420 along the first fold line 422 and the second fold line 424, respectively. Similarly, the first tab 404 and the second tab 406 may be folded with respect to the center panel 420 along the first tab fold line 428 and the second tab fold line 430, respectively. The center panel 420 may also be folded relative to itself along the center fold line 426.

The aforementioned portions of the first panel 416 and the second panel 418 may be folded relative to each other along the creases 432 so that the first tab 404 and the second tab 406 may be secured to the first panel 316 and the second panel 318. The creases 432 may be oriented in any desired manner relative to one another. By way of example, the first panel 416 may define a first slot 408 and a second slot 410. The aforementioned folding may facilitate insertion of the first tab 404 into the first slot 408 and insertion of the second tab 406 into the second slot 410. As a result, the folded shape of the substrate 402 may be maintained.

To further secure the substrate 402 in a folded state, the first panel 416 and/or the second panel 418 may include adhesive portions 436. By way of example, adhesive portions 436 (e.g., an adhesive) may be disposed on the first portion 416A and the second portion 416B of the first panel 416 near and/or adjacent to the first slot 408 and the second slot 410. As such, when the substrate 402 is folded and the first tab 404 and the second tab 406 are inserted into their respective slots, the adhesive portions 436 may be adhered to a portion of the first tab 404 and/or the second tab 406. Similarly, the adhesive portions 436 may also adhere to at least a portion of the faces 434. That is, the first tab 404 and the second tab 406 may be adhered to at least one of the faces 434.

Additionally, crush zones 438 may be located adjacent to the first slot 408 and/or the second slot 410. The crush zones 438 may be configured to form a localized weak area of the substrate 402 to facilitate ease of insertion of the first tab 404 and the second tab 406 into their respective slots. For example, the substrate 402 may be a corrugated paper material and crush zones 438 may be a region of the substrate 402 that may locally crush the flutes within a localized region of the substrate 402 adjacent to the first slot 408 and the second slot 410. However, any means of locally modifying the structural integrity of the substrate 402 may be possible.

FIG. 4B illustrates a top view of a horticulture container 400 that may be formed by the substrate 402 described above. That is, the substrate 402 may be folded or otherwise manipulated to form the horticulture container 400. The horticulture container 400 may be similar to the horticulture container 100 and the horticulture container 300 described above.

As shown in FIG. 4B, the faces 434 of the first panel 416 and the second panel 418 may be folded relative to each other along the creases 432 to form an overall shape of the horticulture container 400. Similarly, the faces 434, including the first panel 416 and the second panel 418 as a whole, may be folded with respect to the center panel 420 to define a cavity 440 of the horticulture container 400. As such, the center panel 420 may form a base support or base of the horticulture container 400 such that, when soil and/or a plant is inserted into the cavity 440, the center panel 420 may support the soil and/or the plant.

The faces 434 of the first panel 416 and the second panel 418 may terminate at one end and form a lip 442 around the cavity 440. That is, the lip 442 may define an opening 444 of the cavity 440 that may permit access to the cavity 440 (e.g., for potting a plant or other horticulture item).

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (e.g., an angle that lies within the range of (approximately) 135° to (approximately) 225°). The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A horticulture container, comprising:
a substrate that is integrally formed and that includes:
faces interconnected and separated by creases, wherein the faces define a cavity of the horticulture container;
a lip formed by the faces and that defines an opening, wherein the cavity is enclosed by the faces and access to the cavity is only permitted through the opening; and
one or more tabs that are secured to at least one of the faces to maintain a shape of the horticulture container.

2. The horticulture container of claim 1, wherein the one or more tabs are secured in one or more slots defined by the substrate.

3. The horticulture container of claim 2, wherein the one or more slots are formed in at least one of the faces.

4. The horticulture container of claim 2, wherein the one or more tabs are adhered to at least one of the faces.

5. The horticulture container of claim 2, wherein the substrate includes a crush zone positioned adjacent to each of the one or more slots.

6. The horticulture container of claim 1, wherein the substrate is a corrugated paper material.

7. The horticulture container of claim 1, wherein the substrate includes one or more panels interconnected and separated by fold lines, and wherein the faces are located on the one or more panels.

8. The horticulture container of claim 7, wherein the one or more panels are configured to be folded relative to each other along the fold lines and the faces are configured to be folded relative to each other along the creases to define and form the shape of the horticulture container.

9. The horticulture container of claim 7, wherein the one or more panels include:
a first panel;
a second panel; and
a center panel located between, and connected to, the first panel and the second panel.

10. The horticulture container of claim 9, wherein the first panel, the second panel, or both include a slot that is configured to receive the one or more tabs.

11. The horticulture container of claim 9, wherein the one or more tabs are located on, or connected to, the center panel.

12. The horticulture container of claim 11, wherein the one or more tabs, the first panel, and the second panel extend from the center panel, and the one or more tabs extend in a direction generally orthogonal to the first panel and the second panel.

13. The horticulture container of claim 9, wherein the first panel and the second panel each include:
a first portion;
a second portion; and
a center portion located between, and connected to, the first portion and the second portion.

14. The horticulture container of claim 13, wherein the center portion of the first panel is connected to the center panel by a first fold line and the center portion of the second panel is connected to the center panel by a second fold line.

15. The horticulture container of claim 14, wherein the first portion and the second portion of the first panel and the first portion and the second portion of the second panel are free of direct connection to the center panel.

16. The horticulture container of claim 1, wherein the creases intersect to form a diamond pattern.

17. A method of forming a horticulture container, comprising:
obtaining a substrate formed from a paper material, wherein the substrate includes:
a first panel that includes faces interconnected by creases,
a second panel that includes faces interconnected by creases,
a center panel located between, and connected to, the first panel and the second panel by a first fold line and a second fold line, respectively,
one or more tabs connected to the center panel by one or more additional fold lines, and
one or more slots formed in the first panel, the second panel, or both;
folding the first panel with respect to the center panel along the first fold line;
folding the second panel with respect to the center panel along the second fold line;
folding the one or more tabs with respect to the center panel along the one or more additional fold lines; and
inserting the one or more tabs into the one or more slots.

18. The method of claim 17, further comprising adhering the one or more tabs to the first panel, the second panel, or both.

19. The method of claim 17, wherein the substrate further includes a center fold line that bisects the center panel and extends in a direction generally parallel to the first fold line and the second fold line, and wherein the method further comprises folding the center panel along the center fold line.

20. The method of claim 17, wherein the first fold line and the second fold line extend generally perpendicular to the one or more additional fold lines.
